(19) United States
(12) Patent Application Publication
(10) Pub. No.: US 2026/0030990 A1
(43) Pub. Date: Jan. 29, 2026

(54) System and Method for Providing Vehicle Maintenance Instructions Using QR Codes

(71) Applicant: Sheyna Kimberly Teran, Fishkill, NY (US)

(72) Inventor: Sheyna Kimberly Teran, Fishkill, NY (US)

(21) Appl. No.: 18/783,588

(22) Filed: Jul. 25, 2024

(51) Int. Cl. G09B 5/02; G06K 19/06

(52) U.S. Cl. CPC G09B 5/02; G06K 19/06037; G06K 19/06075

(57) ABSTRACT

A system for providing vehicle maintenance instructions comprises identification markers with QR codes affixed to vehicle components. Each QR code directs users to a URL linked to a specific video guide stored on a server. The server, in communication with a database, hosts video guides corresponding to various maintenance tasks. A network interface facilitates communication between a user's mobile device and the server. The QR codes, when scanned, provide immediate access to instructional videos tailored to specific vehicle components, simplifying the maintenance process. The system includes options for using heat-resistant, durable vinyl substrates and magnets for marker attachment, and employs high error-correction levels in QR code generation. The video guides can be hosted on third-party platforms, such as YouTube, ensuring broad accessibility. A mobile application further enhances user interaction by scanning QR codes and directing users to the corresponding videos.

### FIELD OF INVENTION

The present invention relates generally to vehicle maintenance systems, specifically to a method and system for providing instructional guides for vehicle maintenance using identification markers with QR codes.

### BACKGROUND

In the realm of automobile maintenance, a significant challenge faced by vehicle owners, especially those with limited technical expertise, is the accessibility and understanding of basic maintenance procedures. Traditional methods require users to consult bulky manuals, navigate through various web pages, or seek assistance from professionals, leading to delays and potential neglect of essential maintenance tasks. This not only increases the risk of vehicle malfunction but also imposes additional costs and inconveniences on the user.

Existing solutions such as printed manuals or generic online videos do not offer the immediacy or specificity needed for efficient maintenance. Manuals can be cumbersome to navigate, often presenting information in a technical jargon that is not easily understood by the average car owner. On the other hand, online resources, while plentiful, require users to sift through irrelevant content to find instructions pertinent to their specific vehicle component and task. This process can be time-consuming and frustrating, leading to decreased compliance with regular maintenance schedules.

Furthermore, while some modern vehicles are equipped with digital maintenance reminders, these systems typically provide alerts without detailed guidance on how to perform the necessary tasks. Consequently, owners are still reliant on external sources to obtain the requisite knowledge, which can be particularly problematic in situations where immediate action is required.

The advent of QR codes offers a potential solution, allowing for direct access to digital content. However, their application in automobile maintenance has been limited and not fully optimized to address the unique needs of vehicle owners. Current implementations, if any, lack a comprehensive approach that integrates easily accessible, component-specific instructional content directly linked to the vehicle's maintenance points.

The need for an innovative system that bridges the gap between vehicle owners and accessible, understandable maintenance instructions is evident. Such a system would empower users by providing instant access to tailored video guides, thereby enhancing their ability to perform routine maintenance tasks independently and efficiently. This would not only improve the upkeep of their vehicles but also foster a greater sense of confidence and autonomy in managing their automotive needs.

It is within this context that the present invention is provided.

### SUMMARY

The present invention relates to a system and method for providing vehicle maintenance instructions using identification markers with QR codes. The system comprises identification markers configured to be affixed to vehicle components, a server storing video guides corresponding to specific maintenance tasks, a database storing URLs linked to the QR codes, and a network interface for communication between the user's mobile device and the server. The system simplifies vehicle maintenance by directing users to specific video guides through the QR codes.

In some embodiments, the substrate of each identification marker is made of a heat-resistant, durable vinyl or plastic material. It can also be made of paper and other suitable materials. This ensures that the identification markers can withstand the high temperatures and harsh conditions found under the hood of a vehicle.

In further embodiments, the identification marker comprises an adhesive backing suitable for adhering to metal and plastic surfaces. This feature allows for secure attachment of the markers to various vehicle components, ensuring they remain in place over time.

In yet further embodiments, the identification marker comprises a magnet configured to attach to metallic surfaces. This provides an alternative method of attachment, particularly useful for components where adhesive may not be suitable.

In some embodiments, the QR codes are generated with a high level of error correction. This ensures the QR codes remain scannable even if they become partially damaged or dirty.

In further embodiments, the server hosts the video guides on a third-party platform, such as YouTube. This leverages existing infrastructure for video hosting, making the system easier to implement and use.

In yet further embodiments, the network interface is a wireless communication interface that connects the user's mobile device to the server via the internet. This facilitates seamless access to the video guides without the need for physical connections.

In some embodiments, the system includes a mobile application installed on the user's mobile device. The application is configured to scan the QR codes and direct the user's device to the corresponding URL, providing a user-friendly interface for accessing the maintenance instructions.

In further embodiments, the mobile application includes additional features such as maintenance reminders and a log of viewed video guides. These features enhance the utility of the system by helping users keep track of their maintenance activities.

In yet further embodiments, the database is configured to store redirect URLs, allowing the QR codes to be updated without replacing the physical identification markers. This ensures the system remains flexible and up-to-date.

In some embodiments, the system includes a mechanism for periodically reviewing and updating the video guides stored on the server. This ensures that the maintenance instructions provided to users are current and accurate.

In further embodiments, each video guide includes instructions specific to the make, model, and year of the vehicle component to which the identification marker is affixed. This ensures that users receive precise and relevant information for their specific vehicle.

In yet further embodiments, the identification markers are placed on or near vehicle components such as the oil dipstick, windshield washer fluid cap, battery terminals, air filter housing, and coolant reservoir. This strategic placement ensures that users can easily find and scan the markers for relevant maintenance instructions.

In some embodiments, the server and database are part of a cloud-based system, allowing for scalable storage and management of video guides and URLs. This provides a robust and flexible infrastructure for the system.

In further embodiments, the video guides are accessible through both a dedicated website and a mobile application. This provides users with multiple options for accessing the maintenance instructions.

In yet further embodiments, the identification markers are designed with different shapes and sizes to fit various vehicle components. This ensures that the markers are appropriately sized and shaped for their intended locations.

In some embodiments, the system includes a method for generating and encoding the QR codes, involving the use of software tools to link each QR code to a specific URL stored in the database. This method ensures that each QR code is correctly linked to its corresponding video guide.

### BRIEF DESCRIPTION OF THE DRAWINGS

Various embodiments of the invention are disclosed in the following detailed description and accompanying drawings.

FIG. 1 illustrates an example system architecture of the vehicle maintenance instruction system with a user scanning a QR code on an identification marker affixed near the oil dipstick of a vehicle.

FIG. 2 illustrates an example computer-implemented method steps involved in a user journey accessing maintenance instructions through their mobile device.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The term “identification marker” refers to any device or material affixed to a vehicle component that contains a QR code or other machine-readable code. This includes, but is not limited to, stickers, magnets, or other durable labels. In one example implementation, the identification marker may be a heat-resistant vinyl sticker with an adhesive backing suitable for adhering to metal and plastic surfaces under the hood of a vehicle. Alternatively, the identification marker may be a rubber-coated neodymium magnet configured to attach securely to metallic surfaces.

The term “QR code” refers to a type of matrix barcode that can be scanned by a mobile device to quickly access a URL or other encoded information. In this invention, the QR code is specifically used to link to video guides for vehicle maintenance tasks. The QR codes are generated with a high level of error correction, allowing them to remain readable even if partially damaged or dirty. In one example implementation, the QR codes are printed on the identification markers using a high-resolution printing process to ensure durability and clarity.

The term “server” refers to a computer system that hosts and delivers video guides corresponding to vehicle maintenance tasks. This includes, but is not limited to, cloud-based servers, local servers, and any other type of data storage and retrieval system. In one example implementation, the server may host the video guides on a third-party platform such as YouTube, linking each QR code to a specific video URL stored in a central database. The server ensures that users can access the correct instructional videos by maintaining an up-to-date database of URLs.

The term “database” refers to a structured collection of data stored and accessed electronically. This includes, but is not limited to, relational databases, NoSQL databases, and other types of data storage systems. In this invention, the database stores the URLs corresponding to the video guides linked to the QR codes on the identification markers. In one example implementation, the database may be part of a cloud-based system that allows for scalable storage and management of the video guides and their associated URLs.

The term “network interface” refers to any hardware or software component that facilitates communication between the user's mobile device and the server. This includes, but is not limited to, Wi-Fi, cellular networks, and other wireless communication protocols. In one example implementation, the network interface may use standard wireless communication protocols such as IEEE 802.11 (Wi-Fi), 4G, 5G, or LTE to connect the user's mobile device to the server, allowing for seamless access to the video guides.

The term “mobile device” refers to any portable computing device that can scan QR codes and access the internet. This includes, but is not limited to, smartphones, tablets, and other similar devices. In one example implementation, the mobile device may use a built-in camera to scan the QR codes on the identification markers and a mobile application to direct the user to the corresponding video guides.

The term “video guide” refers to an instructional video that provides step-by-step instructions for performing a specific vehicle maintenance task. This includes, but is not limited to, videos hosted on third-party platforms like YouTube or videos stored on a proprietary server. In one example implementation, each video guide is tailored to the make, model, and year of the vehicle component to which the identification marker is affixed, ensuring that users receive precise and relevant information.

### DESCRIPTION OF DRAWINGS

The present invention relates to a system and method for providing vehicle maintenance instructions using identification markers with QR codes. This invention addresses the shortcomings of the prior art, where vehicle owners, especially those with limited technical expertise, face challenges in accessing and understanding basic maintenance procedures. Traditional methods such as printed manuals and generic online videos are often cumbersome and time-consuming to navigate, leading to delays and potential neglect of essential maintenance tasks.

The invention comprises identification markers that are affixed to various components under the hood of a vehicle. Each identification marker features a QR code that, when scanned by a user's mobile device, directs the user to a specific URL linked to a video guide stored on a server. These video guides provide step-by-step instructions for performing specific maintenance tasks, such as checking oil levels or refilling windshield washer fluid. By providing immediate, tailored access to maintenance instructions, this system simplifies the maintenance process for vehicle owners, enhancing their ability to perform routine tasks independently and efficiently.

The system includes a server configured to host the video guides, a database storing the URLs linked to the QR codes, and a network interface facilitating communication between the user's mobile device and the server. The identification markers are designed to be durable and capable of withstanding the harsh conditions under a vehicle's hood, ensuring they remain functional over time. This invention leverages widely accessible QR code technology and third-party video hosting platforms, such as YouTube, to provide a versatile and user-friendly solution.

One of the key benefits of this invention is its ability to provide precise and relevant information tailored to the specific vehicle component and maintenance task. In one implementation, unlike traditional manuals and generic videos, the video guides linked through the QR codes are specific to the make, model, and year of the vehicle, ensuring that users receive accurate and practical instructions. Furthermore, the system's ability to update the URLs stored in the database allows for continuous improvement and updating of the video content without the need to replace the physical identification markers.

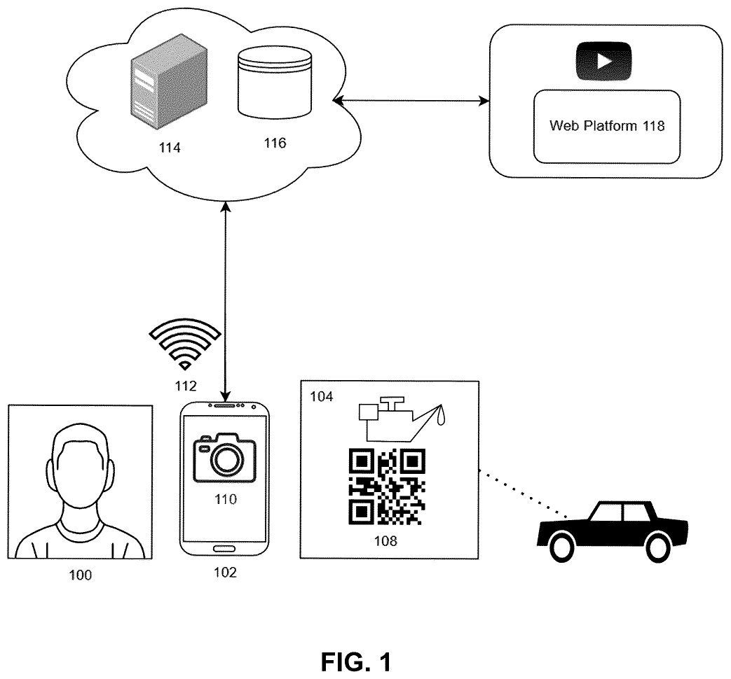

Referring now to the drawings, FIG. 1 illustrates the system architecture of the vehicle maintenance instruction system. In this figure, a user 100 is depicted operating a mobile device 102, such as a smartphone, in proximity to an identification marker 104 affixed near the oil dipstick of a vehicle 106. The identification marker 104 includes a QR code 108 that, when scanned by the mobile device 102, directs the user 100 to a specific URL corresponding to a video guide.

The mobile device 102 is equipped with a camera 110 for scanning the QR code 108 and a wireless communication interface 112 for accessing the internet. Upon scanning the QR code 108, the mobile device 102 sends a request through the wireless communication interface 112 to a cloud server 114. The cloud server 114 is responsible for hosting the system's video guides and is connected to a database 116 that stores the URLs associated with each QR code.

The cloud server 114 retrieves the specific video guide URL from the database 116 and directs the mobile device 102 to the corresponding video guide hosted on a web platform 118, such as YouTube. The web platform 118 streams the video guide to the mobile device 102. The video guide 120 provides step-by-step instructions for checking the oil level using the oil dipstick 106, ensuring the user 100 can perform the maintenance task correctly and efficiently.

The identification marker 104 is depicted as a durable sticker made of heat-resistant vinyl material, designed to adhere securely to the vehicle's components, even in high-temperature environments. The QR code 108 on the identification marker 104 is printed with high-resolution techniques to ensure it remains scannable despite potential exposure to dirt and grime.

In addition to the oil dipstick 106, other types of identification markers can be included to cover various vehicle maintenance tasks. For example:
Battery Terminals Sticker: This sticker would provide a video guide on how to clean and maintain battery terminals, including checking for corrosion and ensuring a secure connection.
Air Filter Housing Sticker: This sticker would link to a video demonstrating how to check and replace the air filter, ensuring optimal engine performance.
Coolant Reservoir Sticker: This sticker would offer a video guide on how to check coolant levels and add coolant if necessary, preventing engine overheating.
Brake Fluid Reservoir Sticker: This sticker would provide instructions on how to check brake fluid levels and top up the brake fluid, ensuring safe braking performance.
Power Steering Fluid Reservoir Sticker: This sticker would link to a video showing how to check and refill power steering fluid, ensuring smooth steering operation.
Spark Plug Housing Sticker: This sticker would provide a video guide on how to inspect and replace spark plugs, which are crucial for engine ignition.

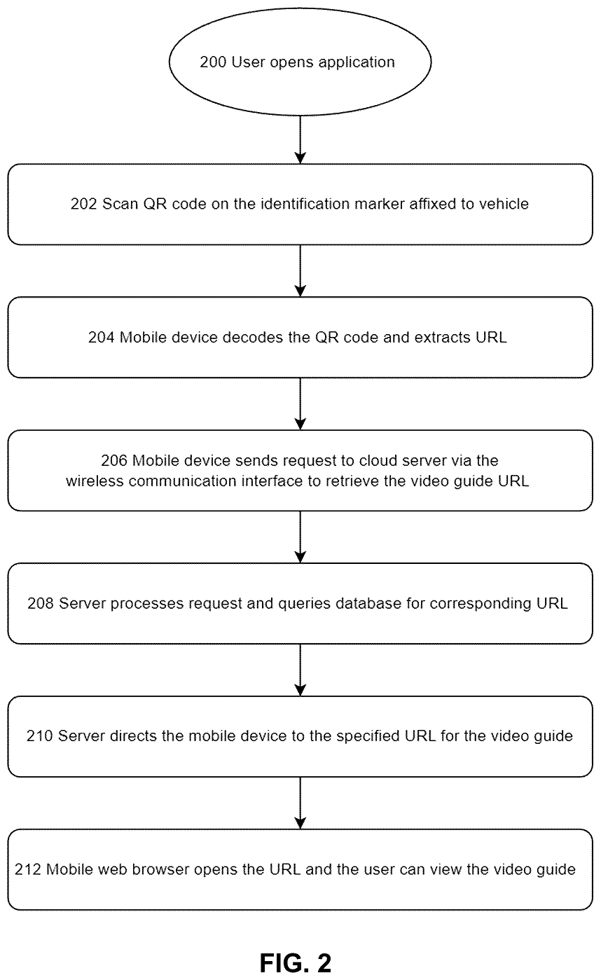

FIG. 2 illustrates the computer-implemented method steps involved in a typical user journey where a user accesses the functionalities of the vehicle maintenance instruction system through their mobile device. This method facilitates the seamless delivery of maintenance instructions via video guides hosted on a web platform. Each step in the method is assigned a reference numeral, starting from 200.

The user 100 initiates the process by opening a mobile application 200 on their mobile device 102. This application is designed to interact with the vehicle maintenance instruction system, providing an interface for scanning QR codes and accessing video guides.

Upon opening the application 200, the user 100 scans the QR code 108 on the identification marker 104 affixed near the oil dipstick 106 (step 202). The mobile application uses the device's camera 110 to capture the QR code 108, which encodes a specific URL associated with a video guide for checking the oil level.

The mobile device 102 then decodes the QR code 108 and extracts the URL (step 204). This URL points to a video guide stored on a web platform 118, such as YouTube, and is managed by a cloud server 114 and a database 116 within the system architecture.

Next, the mobile device 102 sends a request to the cloud server 114 via the wireless communication interface 112 to retrieve the video guide URL (step 206). The cloud server 114 processes the request and queries the database 116 for the corresponding URL (step 208).

Upon retrieving the URL from the database 116, the cloud server 114 directs the mobile device 102 to the specific URL (Step 210). This URL links to a video guide hosted on the web platform 118.

The mobile application 200 or the mobile device's web browser then opens the URL and the user 100 can now view the video guide on their mobile device 102 (step 212). The video guide 120 provides detailed, step-by-step instructions on how to check the oil level using the oil dipstick 106. This allows the user 100 to perform the maintenance task accurately and independently.

Throughout this process, the mobile application 200 may also provide additional functionalities, such as saving a log of viewed video guides, setting maintenance reminders, and offering supplementary information relevant to the vehicle maintenance task. These additional features enhance the overall user experience by ensuring that the user 100 has continuous access to relevant and up-to-date maintenance information.

The stickers and magnets are designed to withstand the harsh conditions under an automobile hood, including high temperatures, exposure to oils and fluids, and physical wear and tear. The stickers could be made from a durable, heat-resistant vinyl such as polycarbonate, with a strong adhesive backing designed for metal and plastic surfaces. The adhesive should be resistant to both heat and moisture to ensure long-term adherence. Magnets, on the other hand, could be made from a rubber-coated neodymium material to prevent rust and provide a firm grip on metallic surfaces. Both stickers and magnets should come in various shapes and sizes to fit different components, such as a small circular design for the oil dipstick and a larger rectangular shape for the windshield washer fluid cap.

The QR codes should be generated using high-quality, high-resolution printing techniques to ensure they remain scannable even after prolonged exposure to harsh conditions. The QR codes can incorporate a high level of error correction (e.g., Level H, which allows up to 30% of the code to be restored) to maintain functionality despite potential damage or dirt. The process of generating and encoding the QR codes would involve using software tools that link each QR code to a specific URL. This ensures each code directs the user to the correct video guide. The codes should be tested for compatibility with a range of smartphone cameras, ensuring they can be easily scanned in low light or with partially obstructed views.

Each video should be tagged and described in a way that clearly identifies the specific maintenance task and vehicle component it covers. To manage and update these links, a central database could be maintained, ensuring that if a video URL changes, the QR code can be quickly updated to reflect the new URL. Additionally, hosting the videos on a platform like YouTube allows for high accessibility, as users are likely already familiar with the interface and it supports various devices and operating systems. Privacy settings on the platform should be configured to protect user data and control access to the content.

The placement of the stickers or magnets would be strategically determined based on common maintenance points under the hood. For instance, a sticker for the oil dipstick could be placed on or near the dipstick handle, while the windshield washer fluid sticker could be affixed to the cap or nearby. Each placement should be easily visible and accessible to the user. The user interface could involve a mobile app or a simple web interface where users scan the QR code and are immediately directed to the relevant video guide. The app or website could also include additional features such as maintenance reminders, a log of viewed videos, and a FAQ section.

To ensure the video content remains relevant and accurate, there should be a mechanism for regularly reviewing and updating the guides. This could involve periodically checking the videos for outdated information and replacing them with updated content. The QR codes can be designed to link to a redirect URL, which can be updated without needing to replace the physical sticker or magnet. For instance, if a video URL changes, only the redirect URL needs to be updated in the database. Users should also be provided with instructions on how to replace worn-out stickers or magnets, which could include ordering replacement parts online. Each new sticker or magnet would come pre-programmed with the correct QR code, ensuring continuity of the maintenance guidance system.

### Controller/Processor Components

The operations described herein can be carried out by any suitable processor or computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and method of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for providing vehicle maintenance instructions, comprising:
a plurality of identification markers, each comprising a substrate configured to be affixed to a component of a vehicle and a QR code disposed on the substrate;
a server configured to store a plurality of video guides, each video guide corresponding to a specific vehicle maintenance task for a specific vehicle component;
a database in communication with the server, the database storing a plurality of URLs, each URL corresponding to one of the video guides and linked to one of the QR codes;
a network interface configured to facilitate communication between a user's mobile device and the server;
wherein each QR code, when scanned by the user's mobile device, directs the user's mobile device to the URL corresponding to the video guide associated with the specific vehicle maintenance task for the specific vehicle component.

2. The system of claim 1, wherein the substrate of each identification marker is made of a heat-resistant, durable vinyl material.

3. The system of claim 2, wherein the identification marker further comprises an adhesive backing suitable for adhering to metal and plastic surfaces under the hood of a vehicle.

4. The system of claim 2, wherein the identification marker further comprises a magnet configured to attach to metallic surfaces under the hood of a vehicle.

5. The system of claim 1, wherein the QR codes are generated with a high level of error correction to ensure readability despite potential damage or dirt.

6. The system of claim 1, wherein the server is further configured to host the video guides on a third-party platform, and the URLs stored in the database are URLs of the third-party platform.

7. The system of claim 1, wherein the video guides are hosted on YouTube, and each QR code links directly to an individual YouTube video URL.

8. The system of claim 1, wherein the network interface is a wireless communication interface configured to connect the user's mobile device to the server via the internet.

9. The system of claim 1, further comprising a mobile application installed on the user's mobile device, the mobile application configured to scan the QR codes and direct the user's mobile device to the corresponding URL.

10. The system of claim 9, wherein the mobile application further comprises a user interface for accessing additional features, including maintenance reminders and a log of viewed video guides.

11. The system of claim 1, wherein the database is configured to store redirect URLs, allowing the URLs linked to the QR codes to be updated without replacing the physical identification markers.

12. The system of claim 1, further comprising a mechanism for periodically reviewing and updating the video guides stored on the server.

13. The system of claim 1, wherein each video guide includes instructions specific to the make, model, and year of the vehicle component to which the identification marker is affixed.

14. The system of claim 1, wherein the identification markers are placed on or near vehicle components selected from the group consisting of oil dipstick, windshield washer fluid cap, battery terminals, air filter housing, and coolant reservoir.

15. The system of claim 1, wherein the server and database are part of a cloud-based system, allowing for scalable storage and management of video guides and URLs.

16. The system of claim 1, wherein the video guides are accessible through both a dedicated website and a mobile application.

17. The system of claim 1, further comprising a method for generating and encoding the QR codes, the method involving the use of software tools to link each QR code to a specific URL stored in the database.

18. The system of claim 1, wherein the identification markers are designed with different shapes and sizes to fit various vehicle components.
